(19) United States
(12) Patent Application Publication
(10) Pub. No.: US 2025/0004530 A1
(43) Pub. Date: Jan. 2, 2025

(54) LIMITED BIT TOGGLING FOR DATA BUS INVERSION

(71) Applicant: Advanced Micro Devices, Inc., Santa Clara, CA (US)

(72) Inventor: Gregg Donley, Santa Clara, CA (US)

(73) Assignee: Advanced Micro Devices, Inc., Santa Clara, CA (US)

(21) Appl. No.: 18/345,940

(22) Filed: Jun. 30, 2023

(51) Int. Cl. G06F 9/30

(52) U.S. Cl. CPC G06F 1/3253

(57) ABSTRACT

The disclosed device includes multiple data elements each configured to send a bit of a bit sequence by toggling at most half of a number of bits from a previously sent bit sequence. The bit sequence can first be biased and then XORed with the previously sent bit sequence. Various other methods, systems, and computer-readable media are also disclosed.

### BACKGROUND

When data is sent across a data bus for a computing device, the data bus itself consumes power, which must be managed by the device and in some instances can reduce power availability for other components (e.g., processors). The data patterns moved across the data bus can affect power consumption. Specifically, when bits are toggled (e.g., when a previously sent bit is “0” and a currently sending bit is “1” or when the previously sent bit is “1” and the currently sending bit is “0”), the data bus can consume more power. Although circuits can be added to minimize bit toggling, such circuits can add complexity, latency, and/or added power consumption that limits the advantages of reduced bit toggling.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for a data bus inversion scheme.

FIGS. 2A-B are diagrams of example bit sequences for a data bus inversion scheme.

FIG. 3A-C are simplified diagrams of example circuits for a data bus inversion scheme.

FIGS. 4A-B are simplified diagrams of example circuits for a data bus inversion scheme.

FIG. 5 is a flow diagram of an exemplary method for a data bus inversion scheme.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a data bus inversion scheme. As will be explained in greater detail below, implementations of the present disclosure limit a number of toggling bits to at most half of the total number of bits being sent. Each data element for sending or receiving a bit can include a flip flop circuit coupled to an XOR gate such that a previously sent (or received) bit of a previously sent (or received) bit sequence is XORed with a currently sent (or received) bit of a currently sent (or received) bit sequence. By biasing the currently sent bit sequence to have at most half the bits being 1, the bit sequence actually sent can require at most half of the bits being toggled. Thus, the systems and methods provided herein can advantageously limit power consumption to a predictable amount such for more efficient power management and utilization in a computing device.

In one implementation, a device for data bus inversion includes a plurality of data elements each configured to send a bit of a bit sequence, wherein the plurality of data elements sends the bit sequence by toggling at most half of a number of bits from a previously sent bit sequence.

In some examples, each of the plurality of data elements comprises a flip flop circuit coupled to an XOR gate. In some examples, for each of the plurality of data elements the XOR gate has inputs including a previously sent bit of the flip flop circuit and a currently sending bit and an output to the flip flop circuit.

In some examples, the device further includes a control circuit configured to bias the bit sequence such that at most half of the biased bit sequence includes logic 1 values. In some examples, the control circuit is configured to bias the bit sequence by inverting the bit sequence when the bit sequence includes more logic 1 values than logic 0 values. In some examples, the control circuit is configured to send an indication of inverting the bit sequence.

In some examples, the device further includes a second plurality of data elements each configured to receive the bit of the bit sequence from a corresponding data element of the plurality of data elements. In some examples, each of the second plurality of data elements comprises a flip flop circuit coupled to an XOR gate. In some examples, for each of the second plurality of data elements the XOR gate has inputs including a previously received bit of the flip flop circuit and a currently received bit.

In one implementation, a system for data bus inversion includes a physical memory, at least one physical processor, a first plurality of data elements each configured to send a bit of a bit sequence, a second plurality of data elements each configured to receive the bit of the bit sequence from a corresponding data element of the first plurality of data elements, and a control circuit configured to bias the bit sequence such that the first plurality of data elements sends the bit sequence by toggling at most half of a number of bits from a previously sent bit sequence.

In some examples, each of the first plurality of data elements comprises a flip flop circuit coupled to an XOR gate that has inputs including a previously sent bit of the flip flop circuit and a currently sending bit and an output to the flip flop circuit. In some examples, each of the second plurality of data elements comprises a flip flop circuit coupled to an XOR gate that has inputs including a previously received bit of the flip flop circuit and a currently received bit.

In some examples, the control circuit is configured to bias the bit sequence such that at most half of the biased bit sequence includes logic 1 values. In some examples, the control circuit comprises a counter for counting logic 1 values in the bit sequence and the control circuit is configured to bias the bit sequence by inverting the bit sequence when the bit sequence includes more logic 1 values than logic 0 values. In some examples, the control circuit is configured to send an indication of inverting the bit sequence. In some examples, the second plurality of data elements is configured to invert the received bit sequence in response to the indication.

In some examples, the previously sent bit sequence corresponds to a first half of two data words and the bit sequence corresponds to a second half of the two data words. In some examples, the system further includes a swizzler circuit for interleaving the two data words

In one implementation, a method for data bus inversion includes (i) biasing a bit sequence such that at most half of the biased bit sequence includes logic 1 values, (ii) producing a sending bit sequence from an XOR of the biased bit sequence and a previously sent bit sequence, and (iii) transmitting the sending bit sequence using a plurality of flop circuits.

In some examples, the method further includes (iv) receiving, via a second plurality of flop circuits, the sending bit sequence, (v) producing a received bit sequence from an XOR of the sending bit sequence and a previously received bit sequence, and (vi) unbiasing the received bit sequence.

In some examples, biasing the bit sequence further comprises inverting the bit sequence. In some examples, transmitting the sending bit sequence further comprises sending an inversion indicator in response to inverting the bit sequence. In some examples, unbiasing the received bit sequence further comprises inverting the received bit sequence in response to receiving the inversion indicator.

Features from any of the implementations described herein can be used in combination with one another in accordance with the general principles described herein. These and other implementations, features, and advantages will be more fully understood upon reading the following detailed description in conjunction with the accompanying drawings and claims.

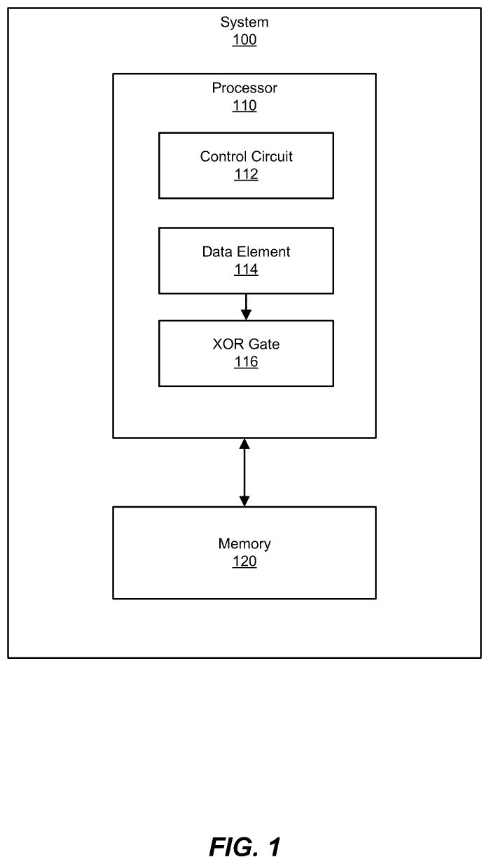

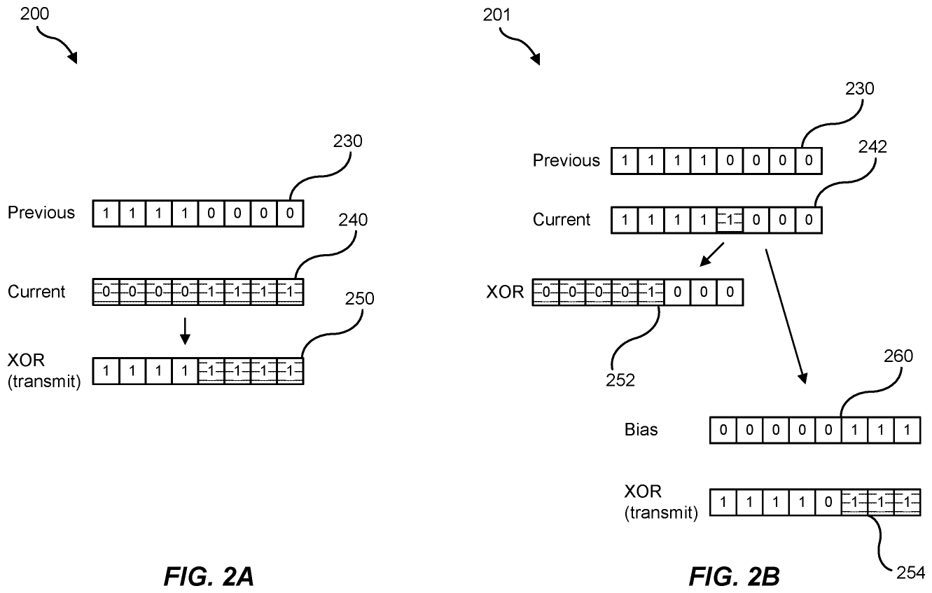

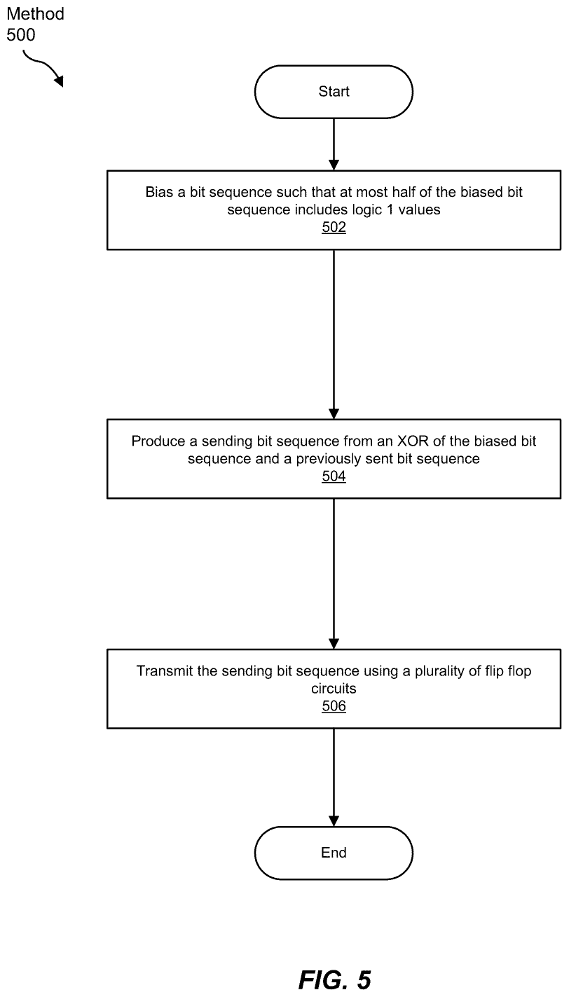

The following will provide, with reference to FIGS. 1-5, detailed descriptions of a data bus inversion scheme. Detailed descriptions of example systems and circuits for a data bus inversion scheme will be provided in connection with FIGS. 1, 3A-3C, and 4A-4B. Detailed descriptions of example bit sequences as modified through a data bus inversion scheme will be provided in connection with FIG. 2. Detailed descriptions of corresponding methods will also be provided in connection with FIG. 5.

FIG. 1 is a block diagram of an example system 100 for data bus inversion. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a control circuit 112, a data element 114, and an XOR gate 116. Control circuit 112 corresponds to circuitry and/or instructions for managing a data bus and/or data fabric. Data element 114 corresponds to one or more circuits for sending and/or receiving data, and in some examples can correspond to a latch circuit, flip flop circuit, etc. XOR gate 116 corresponds to an XOR gate or other circuitry for performing an exclusive-or operation (e.g., outputting 1 when its inputs are 1 and 0 or 0 and 1, and outputting 0 otherwise). Although FIG. 1 illustrates control circuit 112, data element 114, and XOR gate 116 generally as part of processor 110 (e.g., an SOC), in other examples, control circuit 112, data element 114, and/or XOR gate 116 can be located elsewhere in system 100. For instance, one set of control circuit 112, data element 114, and/or XOR gate 116 can be at one edge of the data fabric for sending data to another edge of the data fabric having another set of control circuit 112, data element 114, and/or XOR gate 116. Moreover, although FIG. 1 generally illustrates one control circuit 112, one data element 114, and one XOR gate 116, in other examples, multiple control circuits 112 can each manage sets of data elements 114 and XOR gates 116.

FIGS. 2A-2B illustrate diagrams of various bit sequences, which can correspond to words or other sequences of bits of data (e.g., a portion of a word, a double word, etc.), as a data bus inversion scheme is applied. In FIG. 2A, a diagram 200 includes previous bit sequence 230 and a current bit sequence 240. FIG. 2A illustrates a possible worst case scenario in which 100% of the bits are toggled (e.g., corresponding bits in previous bit sequence 230 and current bit sequence 240 differ), as indicated by the shaded bits.

To reduce the number of toggled bits, previous bit sequence 230 can be XORed with current bit sequence 240 to produce transmit bit sequence 250. As indicated by the shaded bits, a number of toggled bits is reduced from 100% in current bit sequence 240 to 50% in transmit bit sequence 250. The XOR operation can be used to limit the number of toggled bits. More specifically, each 1 value bit that is XORed with previous bit sequence 230 produces a toggled bit.

FIG. 2B illustrates a diagram 201 with previous bit sequence 230 and a current bit sequence 242. Although current bit sequence 242 would produce only 1 toggled bit, circuitry and/or logic to detect such a special case can be prohibitive, whereas a data bus inversion scheme that can be uniformly applied to every bit sequence can be simpler to implement. However, applying XOR to previous bit sequence 230 and current bit sequence 242 can produce an XOR bit sequence 252 in which greater than 50% of the bits are toggled. Thus, to further refine the scheme, current bit sequence 242 can be biased to ensure at most 50% of the bits are 1. As mentioned above, each 1 bit XORed with previous bit sequence 230 produces a toggled bit such that if current bit sequence 242 is biased with at most 50% bits are 1, then at most 50% of XORed bits will be toggled.

Current bit sequence 242 can be biased when a count of its 1 value bits exceeds half of a number of bits in current bit sequence 242. Current bit sequence 242 can be biased, for example, by inversion (e.g., inverting each 0 to 1 and 1 to 0) to produce a biased bit sequence 260. When XORing previous bit sequence 230 with biased bit sequence 260, the resulting bit sequence, a transmit bit sequence 254, can have at most 50% toggled bits (more specifically less than 50% in FIG. 2B). Thus, biasing and XORing provides a data bus inversion scheme that can guarantee that at most 50% of the bits of a bit sequence will be toggled.

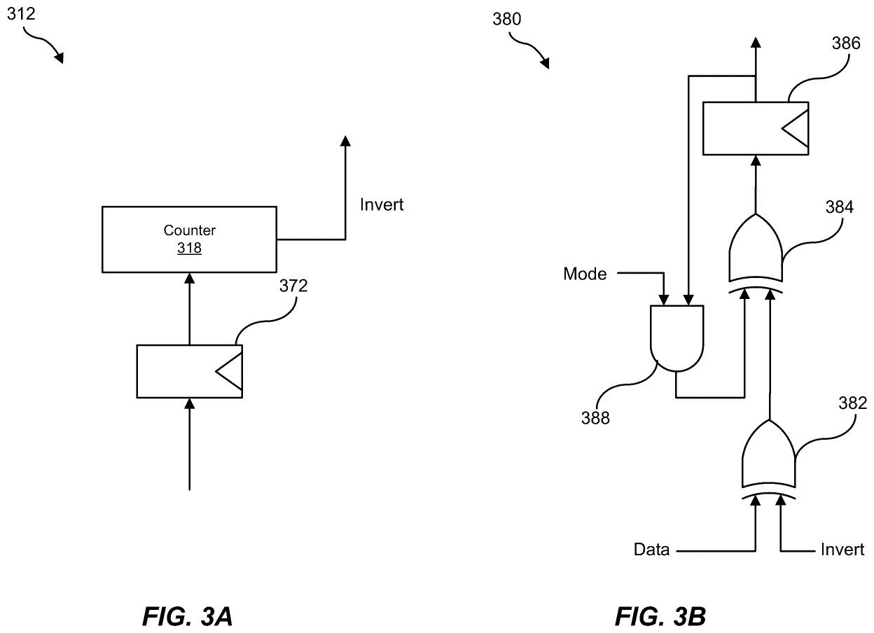

FIGS. 3A-3C illustrate various example circuits for implementing the data bus inversion scheme described herein. FIG. 3A illustrates a control circuit 312 that can correspond to control circuit 112. Control circuit 312 includes an input flop 372 for an input bit sequence, and a counter 318 for counting 1s in the input bit sequence. If a number of 1s exceed half of a number of bits in the input bit sequence (e.g., more 1s than 0s), control circuit 312 can send a signal indicating biasing or inversion such that the biased bit sequence includes at most half the bits being 1. In some examples, control circuit 312 can send the indication using one or more control or status bit signals sent along with the bit sequence. In some examples, control circuit 312 can perform the inversion, although in other examples, described below, a data element circuit can perform the inversion.

FIG. 3B illustrates a data element circuit 380 that can correspond to an iteration of data element 114 for sending a bit of a bit sequence. Data element circuit 380 includes an XOR gate 382, an XOR gate 384 (e.g., XOR gate 116), an output flop 386, and an AND gate 388.

Data (e.g., the bit sequence) can be inverted by XOR gate 382 based on an invert signal (e.g., from control circuit 312) if biasing is needed. The biased signal can be XORed by XOR gate 384 with a previous bit sent by output flop 386. In some examples, a mode signal can allow forwarding the previous bit, via AND gate 388, to XOR gate 384. The XORed bit from XOR gate 384 can be output to output flop 386 for sending (e.g., at a next cycle) across a data bus/data fabric. Thus, XOR gate 384 can have a previously sent bit and a currently sending bit (which may be biased) as inputs, and an output to output flop 386.

FIG. 3C illustrates a data element circuit 390 that can correspond to an iteration of data element 114 for receiving a bit of a bit sequence. Data element circuit 390 includes an input flop 392, a pipeline flop 394, an AND gate 395, an XOR gate 396 (e.g., XOR gate 116), and an XOR gate 398. Data element circuit 390 can receive, at input flop 392, a bit from data element circuit 380. A previous bit, forwarded via pipeline flop 394 and gate 395 (e.g., based on the mode signal) can be XORed with a currently received bit by XOR gate 396. Thus, XOR gate 396 can have a previously received bit and a currently received bit as inputs. If the bit was previously biased or inverted, XOR gate 398 can unbias (e.g., invert) the bit based on the invert signal (e.g., from control circuit 312) for sending the bit.

In some implementations, multiple iterations of data element circuit 380 can each send a bit of a bit sequence to corresponding iterations of data element circuit 390. Thus, multiple data element circuits 380 can send a bit sequence and multiple data element circuits 390 can receive the bit sequence according to the data bus inversion scheme described herein.

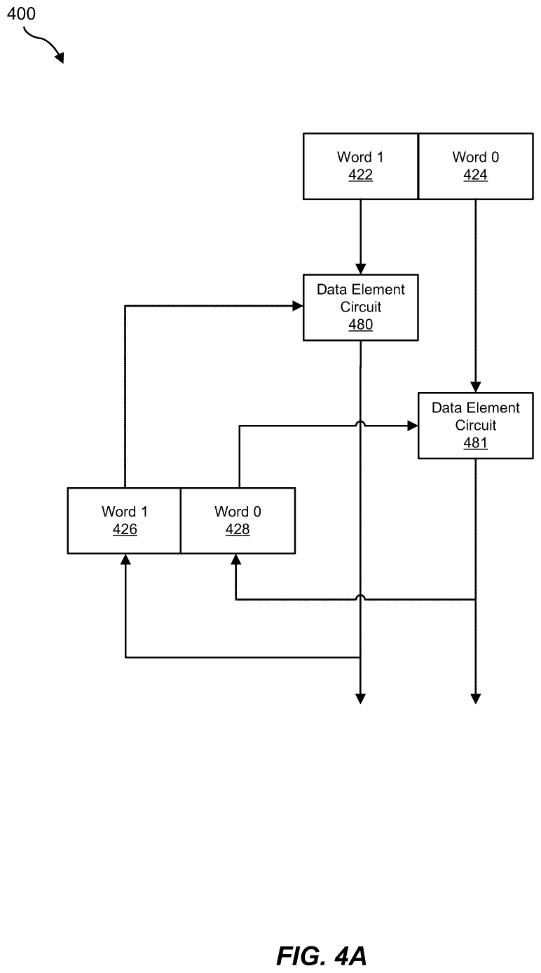

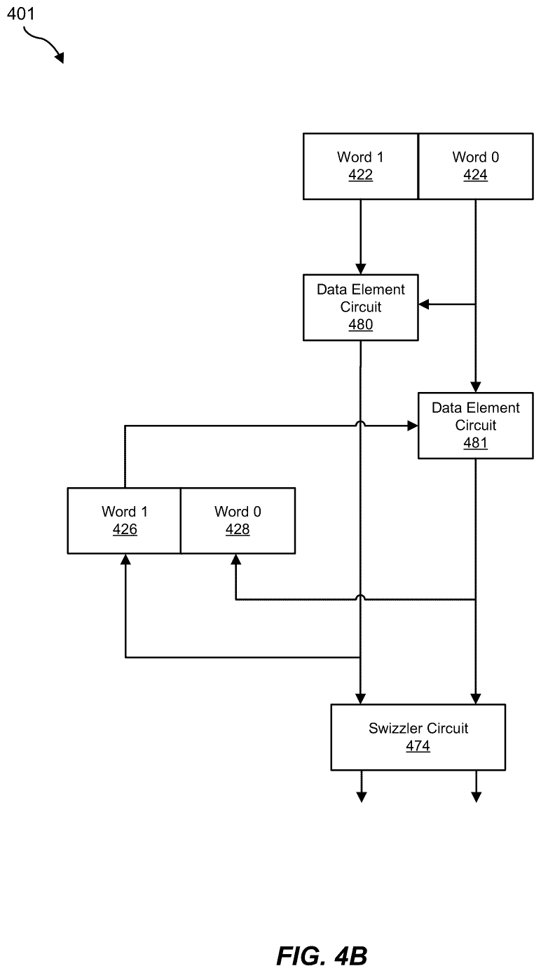

FIGS. 4A-4B illustrate simplified diagrams of a system 400 and a system 401, each corresponding to simplified iterations of system 100, and including a data element circuit 480 and a data element circuit 481, each corresponding to iterations of data element circuit 380 and/or data element circuit 390. FIG. 4A corresponds to a single-pump system in which each word (e.g., word 1 422 and word 0 424) follows a previous word (e.g., word 1 426 and word 0 428), as described above.

FIG. 4B corresponds to a double-pump system in which two values are driven on each wire, and more specifically deinterleaving the words such that a first half of two words are sent in a first clock phase, and the second half of the two words are sent in the next phase. A swizzler circuit 474 can interleave the two data words to ensure that all bits of each word are sent in the same bit-time and allowing the data bus inversion scheme.

FIG. 5 is a flow diagram of an exemplary computer-implemented method 500 for data bus inversion. The steps shown in FIG. 5 can be performed by any suitable circuit and/or system, including the system(s) illustrated in FIGS. 1, 3A-3C, and/or 4A-4B. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein bias a bit sequence such that at most half of the biased bit sequence includes logic 1 values. For example, control circuit 112 can bias a bit sequence as needed to ensure that at most half of the biased bit sequence includes 1s.

The systems described herein can perform step 502 in a variety of ways. In one example, biasing the bit sequence further includes inverting the bit sequence.

At step 504 one or more of the systems described herein produce a sending bit sequence from an XOR of the biased bit sequence and a previously sent bit sequence. For example, XOR gate 116 can produce a sending bit for the sending bit sequence from an XOR of a biased bit from the biased bit sequence and a previously sent bit from a previously sent bit sequence from data element 114.

At step 506 one or more of the systems described herein transmit the sending bit sequence using a plurality of flop circuits. For example, data element 114 can send a bit of the sending bit sequence.

The systems described herein can perform step 506 in a variety of ways. In one example, transmitting the sending bit sequence further includes sending an inversion indicator in response to inverting the bit sequence.

Moreover, method 500 can further include receiving, via a second plurality of flop circuits (e.g., additional iterations of data element 114), the sending bit sequence, producing (e.g., with additional iterations of XOR gate 116) a received bit sequence from an XOR of the sending bit sequence and a previously received bit sequence (from the additional iterations of data element 114), and unbiasing the received bit sequence (e.g., using an additional iteration of control circuit 112). In some examples, unbiasing the received bit sequence further includes inverting the received bit sequence in response to receiving the inversion indicator

As detailed above, limiting power is a concern in nearly all types of chip design. In the case of high performance processors, the frequency and performance of the chip can be limited by the overall power consumption. Power consumption is in part a function of the data patterns being moved across data paths within the chip. The amount of power that must be dedicated to data movement typically must allow for the worst case data patterns. With the systems and methods described herein, the worst case power consumption can be limited to 50% of the data bits toggling, rather than 100% of the bits toggling (e.g., the worst case). Capping the power associated with data movement allows more power to be used for computation resulting in higher performance.

As described herein, the data bus inversion scheme can limit system power consumption by limiting the number of wires that are switching between successive data words on a data bus. This can be achieved by first biasing each word of data towards a minimum number of bits with a one value. In some examples, this biasing can be achieved by inverting any word with a majority of bits with a 1 value. The bus can then be driven with a value that is the exclusive-OR of the word being sent and the word previously sent on the same wires. This results in the number of bits toggling on the bus always being less than or equal to half the number of bits in each word. Thus, the worst case power consumption is capped at 50% of the bits toggling.

The data bus inversion scheme described herein can, in some example, be implemented with minimal amounts of logic added in critical paths (e.g., one XOR gate). Rather than trying to reduce power in all cases, systems and methods described herein can limit the maximum power to 50% of the otherwise worst case. Although in some cases power consumption can be less than ideal for a particular word, and in some cases actually increase power, the data bus inversion scheme described herein can ensure that in all cases, the power consumption is less than or equal to 50% of the worst case.

In addition, in some examples the data bus inversion scheme can be implemented by repurposing existing wires for carrying the necessary information about which words have been inverted. This information is carried on the byte enable bits for data movements where these byte enables are not otherwise used. Moreover, the computation of which words need to be inverted is only performed once, at the edge of the data fabric. This scheme is also flexible in the size of the word that is being inverted, which reduces the number of byte enable, or other such bits required to carry the inversion information.

As detailed above, the circuits and systems described and/or illustrated herein broadly represent any type or form of computing device or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A device comprising:
a plurality of data elements each configured to send a bit based on an input bit sequence, wherein the plurality of data elements sends an output bit sequence by toggling at most half of a number of bits from a previously sent bit sequence; and
a swizzler circuit coupled to the plurality of data elements and configured to interleave portions of one or more bit sequences.

2. The device of claim 1, wherein each of the plurality of data elements comprises a flip flop circuit coupled to an XOR gate.

3. The device of claim 2, wherein for each of the plurality of data elements the XOR gate has inputs including a previously sent bit of the previously sent bit sequence from the flip flop circuit and a currently sending bit based on the input bit sequence and an output to the flip flop circuit.

4. The device of claim 1, further comprising a control circuit configured to control the plurality of data elements to bias the input bit sequence such that at most half of the biased bit sequence includes logic 1 values.

5. The device of claim 4, wherein the control circuit is configured to detect that the input bit sequence includes more logic 1 values than logic 0 values.

6. The device of claim 5, wherein the control circuit is configured to send an indication to the plurality of data elements for inverting the input bit sequence in response to the detecting.

7. The device of claim 1, further comprising a second plurality of data elements each configured to receive the bit of the output bit sequence from a corresponding data element of the plurality of data elements.

8. The device of claim 7, wherein each of the second plurality of data elements comprises a flip flop circuit coupled to an XOR gate.

9. The device of claim 8, wherein for each of the second plurality of data elements the XOR gate has inputs including a previously received bit of a previously received bit sequence from the flip flop circuit and a currently received bit of the output bit sequence.

10. A system comprising:
a physical memory; and
at least one physical processor coupled to the physical memory and comprising;
a first plurality of data elements each configured to send a bit of an output bit sequence based on an input bit sequence;
a second plurality of data elements each configured to receive the bit of the output bit sequence from a corresponding data element of the first plurality of data elements;
a control circuit configured to control the first plurality of data elements to bias the input bit sequence such that the first plurality of data elements sends the output bit sequence by toggling at most half of a number of bits from a previously sent bit sequence; and
a swizzler circuit coupled to the first plurality of data elements and configured to interleave portions of one or more bit sequences.

11. The system of claim 10, wherein:
each of the first plurality of data elements comprises a flip flop circuit coupled to an XOR gate that has inputs including a previously sent bit of the previously sent bit sequence from the flip flop circuit and a currently sending bit based on the input bit sequence and an output to the flip flop circuit; and
each of the second plurality of data elements comprises a flip flop circuit coupled to an XOR gate that has inputs including a previously received bit of the previously received bit sequence from the flip flop circuit and a currently received bit of the output bit sequence.

12. The system of claim 10, wherein the control circuit is configured to control the first plurality of data elements to bias the input bit sequence such that at most half of the biased bit sequence includes logic 1 values.

13. The system of claim 10, wherein the control circuit comprises a counter for counting logic 1 values in the input bit sequence and the control circuit is configured to detect, using the counter, that the input bit sequence includes more logic 1 values than logic 0 values.

14. The system of claim 13, wherein the control circuit is configured to send an indication to the first plurality of data elements for inverting the bit sequence in response to the detecting.

15. The system of claim 14, wherein the second plurality of data elements is configured to invert the received bit sequence in response to the indication.

16. (canceled)

17. (canceled)

18. A method comprising:
biasing an input bit sequence from a plurality of flip flop circuits such that at most half of the biased bit sequence includes logic 1 values;
producing an output bit sequence from an XOR of the biased bit sequence and a previously sent bit sequence;
producing, using a swizzler circuit, a sending bit sequence based on interleaving portions of the output bit sequence that correspond to a single data word; and
transmitting the sending bit sequence.

19. The method of claim 18, further comprising:
receiving, via a second plurality of flip flop circuits, the sending bit sequence;
producing a received bit sequence from an XOR of the sending bit sequence and a previously received bit sequence; and
unbiasing the received bit sequence.

20. The method of claim 19, wherein:
biasing the input bit sequence further comprises inverting the input bit sequence;
transmitting the sending bit sequence further comprises sending an inversion indicator in response to inverting the input bit sequence; and
unbiasing the received bit sequence further comprises inverting the received bit sequence in response to receiving the inversion indicator.

21. The device of claim 1, wherein the swizzler circuit is configured to interleave a deinterleaved first half of a first data word with a deinterleaved second half of the first data word and to interleave a deinterleaved first half of a second data word with a deinterleaved second half of the second data word.

22. The system of claim 10, wherein the swizzler circuit is configured to interleave a deinterleaved first half of a first data word with a deinterleaved second half of the first data word and to interleave a deinterleaved first half of a second data word with a deinterleaved second half of the second data word.
